(19) United States
(12) Patent Application Publication
(10) Pub. No.: US 2015/0226185 A1
(43) Pub. Date: Aug. 13, 2015

(54) WIND FARM

(71) Applicant: Wobben Properties GmbH, Aurich (DE)

(72) Inventor: Alfred Beekmann, Wiesmoor (DE)

(21) Appl. No.: 14/423,968

(22) PCT Filed: Aug. 23, 2013
(86) PCT No.: PCT/EP2013/067590

§ 371 Date: Feb. 25, 2015

(30) Foreign Application Priority Data
Aug. 30, 2012 (DE) 10 2012 215 422.1

(51) Int. Cl. F03D 9/00; H02J 3/38

(52) U.S. Cl. CPC F03D 9/005; H02J 3/38

(57) ABSTRACT

The invention concerns a wind farm for generating electrical energy from wind, including at least 2 wind turbines for producing the electrical energy and a collective injection device for injecting the electrical energy generated, or part of it, into an electrical supply grid, whereby the wind turbines are connected to the injection device via an electrical DC voltage grid, in order to supply the electrical energy generated using the wind turbines as electrical direct current to the injection device.

### BACKGROUND

1. Technical Field

This invention relates to a wind farm for producing electrical energy from wind and for injecting the generated electrical energy into an electrical supply grid. This invention also relates to a method for injecting electrical energy generated on a wind farm by multiple wind turbines.

2. Description of the Related Art

It is generally known that electrical energy is generated by wind turbines from wind, where the term “generate” is used to describe that energy from the wind is converted into electrical energy. Often, multiple wind turbines are grouped together in one wind farm. Such a wind farm then has a collective injection point for supplying electrical energy into an electrical supply grid attached to it. All wind turbines in the wind farm therefore supply electrical energy into the electrical supply grid via this collective injection point.

For example, supplying takes place in such a way that every wind turbine provides its electrical power as an alternating electric current to the electrical supply grid at the appropriate frequency, voltage amplitude and phase. Currents provided in this way from multiple wind turbines are superimposed at, or shortly before, the collective injection point and can therefore be supplied into the electrical supply grid together.

In this way, any of the wind turbines in a wind farm can be operated together, because every wind turbine conditions the electrical current it is providing according to the correct values. It may then be necessary for all of the power being provided to be coordinated.

However, the disadvantage in this case is that losses can occur at every wind turbine and in an internal wind farm grid, which creates a coupling between the wind turbines and the collective grid injection point, which could impair the overall efficiency of the wind farm as a result.

The German Patent and Trademark Office has researched the following prior art in the priority application for this application: DE 101 45 346 A1 and DE 196 20 906 A1.

### BRIEF SUMMARY

One of more embodiments of the present invention is may reduce one or more of the above-mentioned disadvantages. In one embodiment, the loss of performance inside the wind farm shall be reduced and the wind farm's efficiency shall be increased.

According to one embodiment of the invention, a wind farm is provided for generating electrical energy from wind, and includes at least two wind turbines for the generation of electrical energy and one common feed-in device for supplying the electrical energy generated into a connected electrical supply grid. It may also be necessary, particularly temporarily, that only a part of the electrical energy that has been or could be generated is supplied into the electrical supply grid, if for example, this is required in order to support the electrical supply grid and/or based on specifications from the electrical supply grid operator. Otherwise, any power loss is omitted from the fundamental explanation of the invention. For the purposes of basic understanding, it is assumed that the electrical power being generated in the middle can also be supplied to the supply grid. If and when there is a loss of performance, this will be mentioned specifically.

In the proposed solution, the wind turbines are connected to the feed-in device via a DC voltage grid, which can also be referred to as a DC voltage wind farm grid. In this way, the wind turbines supply their electrical energy or their electrical power, if any instantaneous state is considered, as electrical DC current to the DC voltage grid and this DC voltage, or these combined DC voltages from all of the wind turbines involved, is/are supplied to the feed-in device. The feed-in device now receives the total electrical output from the wind farm and can supply this to the electrical supply grid.

This could also refer to supplying electrical DC voltage into the electrical DC voltage farm grid, such that the feed-in device draws the electrical power from the electrical DC voltage wind farm grid. To avoid confusion with the electrical supply grid, the term feeding into the DC voltage grid will be used here.

It is therefore proposed that a DC voltage wind farm grid should be provided, and that the wind turbines connected to it also only feed DC current and DC voltage into this DC voltage wind farm grid. Therefore, the feed-in for the wind farm and therefore for multiple wind turbines can be managed by one single feed-in device. This is the element utilized to generate alternating current, which is adapted to the electrical supply grid in its frequency, voltage amplitude and phase. Any requirements, including requirements which have suddenly changed in the electrical supply grid, need only be provided by this feed-in device. It is this single feed-in device that detects the grid status, i.e., this feed-in device spontaneously allows for the appropriate values. It should also be noted that it is possible to position the feed-in device immediately beside or in close proximity to the feeding point, i.e., in close proximity to the electrical supply grid. This allows a more direct application of any measured values because, e.g., no or only slight loss of voltage occurs between the feed-in device and the electrical supply grid.

Therefore, any loss of voltage between the respective wind turbines and the feed-in point no longer needs to be considered when supplying. Rather the feed-in device may adjust the voltage of the current signal it is generating to the voltage of the electrical supply grid. Due to the shorter distances between this feed-in device and the electrical supply grid, compared to the distance between a wind turbine in the wind farm and the electrical supply grid, voltage amplitudes can also be better adapted to the requirements of the electrical supply grid.

Finally, frequency inverters that were previously required in the wind turbines are no longer required. Now, only one feed-in device is required. This single feed-in device must in fact transform the entire output from the wind farm and must therefore be correspondingly larger in size. However, this means it may be more efficient and therefore be operated with lower relative power loss.

According to an embodiment, it is proposed that the DC voltage in the DC voltage grid ranges from 1 to 50 kV, and specifically from 5 to 10 kV. This refers to the voltage between two cables in a single bipolar topology.

The wind turbines therefore supply their power at a correspondingly high voltage, namely at a medium voltage into the DC voltage grid of the wind farm. Transmission losses may be reduced by such a correspondingly high voltage in the DC voltage grid of the wind farm. Moreover, the voltage is already available to the common feed-in device at a certain amplitude, and can therefore negate the use of a transformer to step up electrical voltage inside the wind farm power grid. It can therefore be operated in the injection device using a medium-voltage inverter, i.e., the collective injection device can be a medium-voltage inverter, which requires less materials and may also make the use of a medium-voltage transformer redundant.

Preferably, at least one of the wind turbines, but particularly all of the wind turbines in the wind farm, will have a generator, a rectifier and a boost converter. The generator is coupled with an aerodynamic rotor on the wind turbine and can therefore generate electrical power from the wind, which it delivers as electrical alternating current. The electrical alternating current is rectified by the rectifier into an initial direct current with an initial DC voltage. The boost converter raises the initial direct current and the initial DC voltage to a second direct current and a second DC voltage, and the second DC voltage is therefore higher than the initial DC voltage. The second DC voltage is then preferably fed into the DC voltage grid of the wind farm. The boost converter is therefore used to step up the initial direct current, specifically to the voltage amplitude required in the DC voltage grid. At the same time, the boost converter can perform the function of delivering a second DC voltage which is as steady as possible. The initial DC voltage can of course vary depending on wind fluctuations, and at low wind speeds it may generate a lower value than at higher wind speeds, or more particularly at a nominal wind speed.

The rectifier is preferably situated in close proximity to the generator, specifically inside the wind turbine nacelle, and the initial direct current generated will then be transferred downwards through a wind turbine tower, or similar, to a tower base, or similar, where the boost converter is located. This means that the electrical output from the nacelle to the tower base, or similar, can take place using DC voltage transmission. At the same time however, the high medium-voltages provided in any case at height can be avoided, where they are envisaged in the DC voltage grid of the wind farm.

According to another design, it is proposed that at least one of the wind turbines, and preferably all of the wind turbines in the wind farm, have a synchronous generator to generate electrical alternating current. This type of synchronous generator is able to reliably generate an electrical alternating current and supply a rectifier. The synchronous generator will preferably be designed as a ring generator, and its electromagnetically active elements will therefore be situated only on the external third or even further out. Preferably, such a synchronous generator can be equipped with a high number of poles, such as 48, 72, 96 or 144 poles for example. This allows for a gearless design, in which a runner in the generator can be directly operated by an aerodynamic rotor, i.e., without interconnected gears, and alternating current, which is transmitted to the rectifier, can be generated directly. Preferably, it will also be a synchronous generator with six phases, i.e., with two lots of three phases. This type of six-phase alternating current can be rectified more easily with narrower harmonics, i.e., smaller filters may suffice. Preferably, the wind turbines will be variable speed turbines, so that the rotation speed of the aerodynamic rotors can be continually adapted to the prevailing wind speed.

According to one design, the injection device has an inverter connected to the DC voltage grid, i.e., the injection device is an inverter. This inverter generates the electrical alternating current being supplied into the electrical supply grid. Preferably a medium-voltage inverter will be used here.

It is advantageous to use a transformer between the injection device and the electrical supply grid to step up the AC voltage being generated by the injection device. If a medium-voltage inverter is used, a medium-voltage transformer is not required. Depending on the electrical supply grid connected and the topology in between, it may be useful to use a high-voltage transformer here. A high-voltage transformer is particularly useful when a medium-voltage inverter is already generating an alternating current with a medium voltage, specifically with a voltage from 5 to 10 kV, and/or if a medium-voltage transformer is being used, which is generating the highest possible medium voltage of up to 50 kV.

According to one embodiment of the invention, a process for supplying electrical energy into an electrical supply grid is also proposed. According to that process, electrical alternating current is generated using a generator in a wind turbine, and rectified by a rectifier into an initial direct current and an initial DC voltage. This initial DC voltage may vary in amplitude. This initial direct current and the initial DC voltage is therefore stepped up to a second direct current with a second DC voltage by a boost converter. This second DC voltage specifically has a greater amplitude than the initial DC voltage and is adapted to the voltage in the DC voltage wind farm grid, i.e., the overall DC voltage grid in the wind farm.

This second direct current and the second DC voltage are correspondingly fed into the DC voltage wind farm grid. This DC voltage wind farm grid supplies this fed-in energy to a collective inverter or a multi-input inverter, which can also be referred to as the wind farm inverter, which inverts this energy supplied as direct current and supplies it into the electrical supply grid as alternating current.

Preferably, multiple wind turbines will generate electrical alternating current (i.e. AC electrical signal), invert this into the initial direct current (i.e. initial DC electrical signal), step up the initial direct current into a second direct current (i.e. DC electrical signal), and finally feed the second direct current into the DC voltage wind farm grid. The terms “initial direct current”, “initial DC voltage” and “second direct current” are to be understood as systematic terms in this context, and amplitudes of the initial direct current, the initial DC voltage and the second direct current may vary from one wind turbine to another. Even if identical wind turbines are used, values can vary, e.g., depending on the prevailing wind and/or the position of the wind turbine concerned inside the wind farm. However, the second DC voltage should in any case be the same for all wind turbines in the initial approximation and correspond to the DC voltage in the DC voltage wind farm grid.

### BRIEF DESCRIPTION OF THE SEVERAL VIEWS OF THE DRAWINGS

The invention will now be explained in more detail using embodiments and with reference to the accompanying figures as examples.

FIG. 1 shows a wind turbine to be used in a wind farm in a perspective view.

FIG. 2 shows a wind farm.

### DETAILED DESCRIPTION

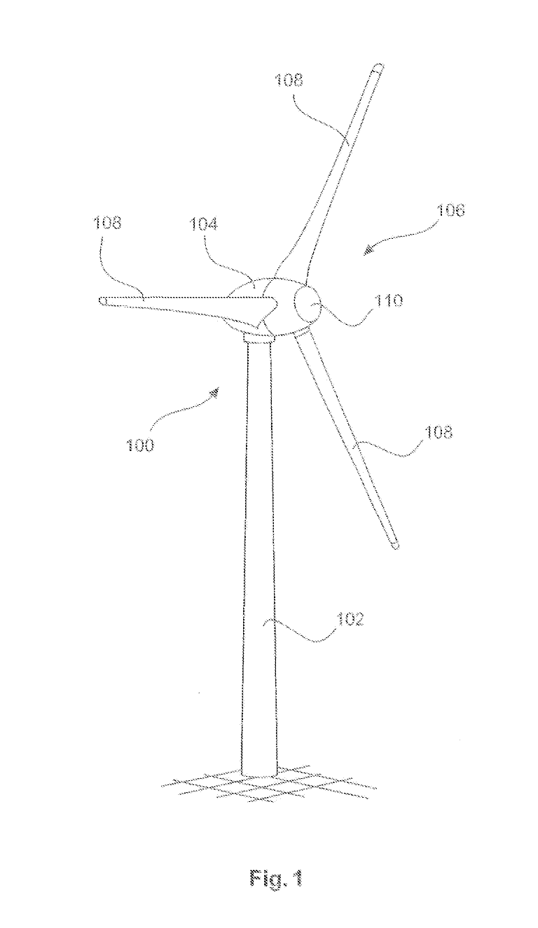

FIG. 1 shows a wind turbine 100 with a tower 102 and nacelle 104. An aerodynamic rotor 106 with three rotor blades 108 and a spinner 110 is located on the nacelle 104. The rotor 106 is set in operation by the wind in a rotating movement and thereby drives a generator in the nacelle 104.

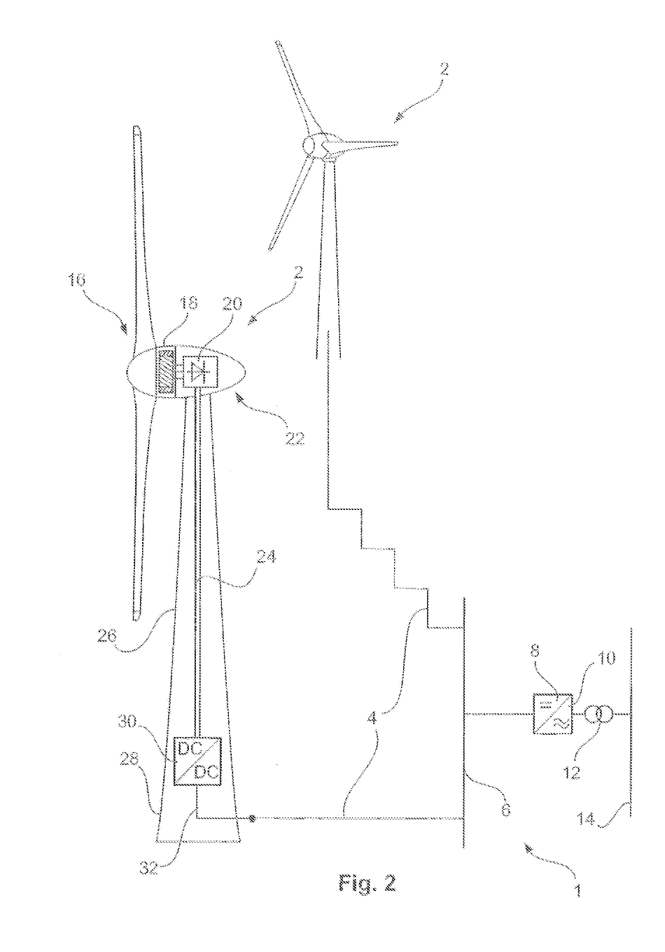

FIG. 2 shows a wind farm 1, which has two wind turbines 2 as an example, one of which is annotated in more detail. These details were not repeated for the other turbine for the sake of simplicity, but it is to be noted that some of its details of the other turbine may be different. Both wind turbines 2 are connected by a DC voltage line 4 and a DC voltage busbar 6 to a collective inverter 8 or multi-input inverter. The collective inverter 8 generates alternating current with an AC voltage from the DC voltage or the direct current from the busbar 6 at its output 10 and supplies this into an electrical supply grid 14, via a transformer 12, which here is designed to be a medium-voltage transformer.

The basic functionality and necessary elements are in any case explained according to an embodiment based on the detailed wind turbine 2 shown. Wind turbine 2 has an aerodynamic rotor 16, which is turned by the wind and therefore turns a runner in a synchronous generator 18, so that the synchronous generator 18 generated alternating current and supplies this to the rectifier 20. The rectifier 20 is located in the nacelle 22 of the wind turbine 2 and there it generates an initial direct current and an initial DC voltage. The initial direct current and the initial DC voltage are supplied via a direct current connection cable 24 from the nacelle 22 via the tower 26 to the tower base 28. The direct current connection cable 24 can therefore also be called a direct current tower cable.

In the tower base 28, the direct current connection cable 24 is coupled to a boost converter 30. The boost converter 30 transforms the initial direct current and the initial AC voltage into a second direct current and a second DC voltage. This second direct current and the second DC voltage is generated at the output 32 of the boost converter 30 and fed in via the single DC voltage cable 4 to the busbar 6.

The initial DC voltage of the initial direct current, which occurs on the direct current connection cable 24, i.e., direct current tower cable 24, and therefore at the output of the inverter 20 is approximately 5 kV. The DC voltage applied to the DC voltage cable 4, i.e., the DC voltage connection 4, at the busbar 6 will preferably be 5 to 10 kV. This value is accordingly also applied at the busbar 6 and therefore at the input to the collective inverter 8. Accordingly, the example shows the collective inverter 8 for transforming a direct current from 5 to 10 kV. The collective inverter 8, which is therefore essentially a feed-in device, is therefore shown as a medium-voltage inverter.

By using the topology illustrated, one inverter in every wind turbine 2 can be omitted. The collective inverter 8 being used can be operated, particularly when a medium-voltage inverter is used, as is also proposed in Figure 2, with greater efficiency than would be possible for this with many individual inverters with lower voltages. FIG. 2 shows two wind turbines 2 in total, which is only intended to illustrate that multiple wind turbines 2 are present in the wind farm 1. However, such a wind farm will preferably have more than two wind turbines 2, specifically 50 wind turbines or more, which are all connected via a DC voltage cable 4 to the busbar 6. The whole of the DC voltage cable 4 can therefore be called the DC voltage wind farm grid 4 or simply the DC voltage grid 4 in the wind farm. The DC voltage wind farm grid 4 is therefore not required to make any direct connection between individual wind turbines, which means, however, that there can be an indirect connection, such as is shown via the busbar 6 in Figure 2.

Depending on the design of the wind farm 1 and/or the electrical supply grid 14, the medium-voltage transformer 12 can be omitted. All of the electrical power generated by the wind turbines 2 is supplied to the DC voltage grid 4 at the highest possible voltage, and is therefore supplied into the electrical supply grid 14 in the most efficient way possible using the collective inverter 8.

This means overall increases in the efficiency of the wind farm 1 are possible, specifically by reducing losses. Furthermore, it is possible to address some of the future requirements of the grid. Such grid requirements may, for example, be that a wind farm has to react to specific conditions in the electrical supply grid in a very deterministic way, or that it must react to requirements from the operator of the electrical supply grid in a particularly deterministic and clear way. Such requirements may also be specified very suddenly through appropriate signals. By using this collective inverter 8, the wind farm 1 can be described as a wind farm generating station, which is only perceived by the electrical supply grid as a major electricity generator. Any differences in the wind turbines 2 in the wind farm 1 have no impact on or are not essential to the electrical supply grid 14, or may not be perceived by the electrical supply grid 14. These particularly include different time behaviors when operating on different statuses in the electrical supply network and/or different requirements from the electrical supply network 14.

It is therefore specifically proposed that all wind farm cabling should use DC voltage technology and a voltage range in the medium voltage range, specifically from approximately 5 to 10 kV. The wind turbines will not be equipped with inverters. The transfer of energy to a grid transmission station, illustrated in FIG. 2 as inverter 8 and busbar 6, will take place using DC voltage. A medium-voltage inverter for supplying into the AC voltage grid, namely the electrical supply grid 14, will therefore be used at the grid transmission station. This medium-voltage inverter meets all of the grid requirements, i.e., the requirements of the electrical supply grid, and also any reactive power requirements, i.e., requirements based on a proportion of reactive power to be supplied.

A solution is therefore proposed which also meets the aims of constructing wind power plants in the most cost-efficient manner and with the highest possible efficiency level.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind farm for generating electrical energy from wind, the wind farm comprising:
a plurality of wind turbines for generating electrical energy;
a common feed-in device for feeding at least a portion of the electrical energy generated to an electrical supply grid; and
an electrical DC voltage grid coupling the plurality of wind turbines to the common feed-in device, the electrical DC voltage grid being configured to supply the electrical energy generated by the respective wind turbines as a DC electrical signal to the common feed-in device.

2. The wind farm according to claim 1, wherein the DC voltage grid has an electrical DC voltage in the range of 1 to 50 kV.

3. The wind farm according to claim 1, wherein each wind turbine has the following:
a generator for generating an AC electrical signal;
a rectifier for rectifying the AC electrical signal generated into a first DC electrical signal having a first DC voltage; and
a boost converter for raising the first DC electrical signal to a second DC electrical signal having a second DC voltage that is higher than the first DC voltage.

4. The wind farm according to claim 1, wherein at least one the plurality of the wind turbines has a synchronous generator for generating an AC electrical signal.

5. The wind farm according to claim 1, wherein the common feed-in device has an inverter coupled to the DC voltage grid, wherein the inverter is configured to generate an AC electrical signal for supplying to the electrical supply grid.

6. The wind farm according to claim 1 further comprising a transformer between the electrical supply grid and the common feed-in device, the transformer being configured to boost the an AC electrical signal generated by the common feed-in device.

7. A method for supplying electrical energy generated in a wind farm of a plurality of wind turbines to an electrical supply grid, the method comprising:
generating a first AC electrical signal using a generator of at least one of the plurality of wind turbines;
converting the first AC electrical signal into an initial DC electrical signal;
boosting the initial DC electrical signal into a second DC electrical signal;
feeding the second DC electrical signal into a DC voltage wind farm grid to supply the second DC electrical signal to a wind farm inverter;
using the wind farm inverter, converting the second DC electrical signal into a second AC electrical signal; and
supplying the second AC electrical signal to an electrical grid supply.

8. The method according to claim 7, wherein:
generating the first AC electrical signal comprises generating a plurality of first AC electrical signals using a plurality of generators of a plurality of wind turbines, respectively;
converting comprises converting the plurality of first AC electrical signals into a plurality of initial DC electrical signals;
boosting comprises boosting the plurality of initial DC electrical signals into a plurality of second DC electrical signals;
feeding comprises feeding the plurality of second DC electrical signals to a DC voltage wind farm grid;
the method further comprising combining the second DC electrical signals into a combined DC electrical signal; and
wherein converting comprises converting the combined DC electrical signal into a second AC electrical signal.

9. The method according to claim 7 wherein the second DC electrical signal that has voltage in a range of about 5 and 10 kV.
